(19) United States
(12) Patent Application Publication
(10) Pub. No.: US 2004/0173701 A1
(43) Pub. Date: Sep. 9, 2004

(54) Device for crushing plastic products and/or semi-manufactured products in particular for the purpose of their recycling

(75) Inventors: Jiri Appeltauer, Zamberk (CZ); Miroslav Lipensky, Zamberk (CZ); Jaroslav Hajek, Kunvald (CZ)

Correspondence Address: OSTROLENK FABER GERB & SOFFEN, 1180 AVENUE OF THE AMERICAS, NEW YORK, NY, 100368403

(73) Assignee: Rieter CZ a.s.

(21) Appl. No.: 10/793,201

(22) Filed: Mar. 4, 2004

(30) Foreign Application Priority Data
Mar. 5, 2003 (CZ) PV 2003-645

(51) Int. Cl. B02C 18/16

(52) U.S. Cl. 241/159

(57) ABSTRACT

To crush products and/or semi-manufactured products of plastic material, for example polypropylene comprising fiberglass or another armoring fiber or from a non-armored plastic material, a supporting frame of a crushing device has a shared space for a first crushing section including a pair of parallel first crushing rolls each fitted with teeth and a second crushing section including a pair of parallel second crushing rolls fitted with teeth. The second section is positioned below the first section and the axes of the second crush rolls of the second crushing section are in the floor projection positioned approximately perpendicular to the axes of the first crush rolls of the first crushing section. The shared space is interconnected with a vacuum source through a filtering device. A feed hopper has a crushed material conveyor.

### TECHNICAL FIELD

The invention relates to a device for crushing products and/or semi-manufactured products from plastic material such as polypropylene containing fiberglass or another armoring fiber or from a non-armored plastic material e.g. PET bottles, where the device comprises a first crushing section of parallel crush rolls fitted with teeth and a second crushing section of parallel crush rolls fitted with teeth wherein both sections are positioned in a shared space fitted with a filler opening on one side and with a crushed substrate storage bin on the other side.

### BACKGROUND ART

A substantial range of plastic products consists of disposable containers and similar relatively bulky objects which are important to dispose of in an environmentally friendly way considering their long natural decay time. One part of their disposal consists of crushing them into small pieces which makes the other disposal steps easier or enables use of the pieces as a recycled material for a new production.

The crushing of plastic objects is mostly carried out by one or more pairs of parallel crush rolls in series. The mechanical processing can sometimes be combined with treating with chemicals or by a specific physical environment.

According to U.S. 573.471, before mechanical processing the disposed plastic material is shortly hardened by means of a low temperature which simplifies its crushing.

According to CZ 284.889 the parallel rows of rolls positioned above each other are placed in a gas chamber where erosive action of a gas, e.g. ozone, makes the mechanical deformation of the processed material easier.

According to U.S. Pat. No. 4,629,134 there are two contra rotating meshing toothed rolls coupled with a static spiked grid which can for cleaning or repair purposes be lifted off the rollers.

Plastic material disposal, in particular disposal of plastics comprising glass fibers, is in general a technical and an environmental problem. For instance, the dust formed by separated parts of a fiberglass during crushing the armored plastics is due to its high buoyancy and the dust easily spread beyond the area of the actual milling and crushing devices.

Another drawback is the presence of uncontrolled, mutually unequal sizes of crushed solid parts of fiberglass-armored plastics in the mixture causes dust formed by separated glass fibers which cannot be used for further new manufacturing and which can only be disposed of easier than initial products of often larger sizes.

Unequal and inconvenient size of the crushed parts is the main drawback also in known devices for recycling non-armored plastic material, e.g. PET bottles, because for further use of plastics as a recycled material considering desired properties of final products, there is a compliance of specific size of crushed solid parts required.

### SUMMARY OF THE INVENTION

The aim of the invention is to eliminate the mentioned drawbacks, to increase the portion of recyclable solid parts in the crushed material and in addition to prepare the solid parts of the crushed material so that their size is optimal for new manufacturing.

The goal of the invention is achieved by a device for crushing plastic products, non-armored or armored by e.g. fiberglass, the device comprising a first section of parallel crush rolls fitted with teeth and a second section of parallel crush rolls fitted with teeth wherein both sections are positioned in a shared space fitted with a filler opening on one side and with a crushed substrate storage bin on the other side. The principle is that both crushing sections are positioned below each other and the axes of the crush rolls of the second crushing section are in the floor projection positioned approximately perpendicularly to the axes of the crush rolls of the first crushing section, and the shared space is interconnected by a feed hopper with a conveyor and through a filtering device with a vacuum source.

The tooth spacing of the tooth system of the first crushing section is larger than the tooth spacing of the second crushing section and the former section can have larger teeth. The processed plastic products are by successive steps crushed in the first and then in the second crushing section for producing crushed parts of an appropriate size for recycling. The size of the crushed parts depends on the selection of construction parameters of the crushing device, particularly on the size and the shape of the rolls and on their spin velocity.

The device does not produce dust outside itself except for the filler opening for inserting the processed plastic products. A feed hopper is positioned in the lower part below the crushing sections. After the hopper, the device continues with a filtering device with suction of dust formed from parts of fiberglass detached while crushing, and the conveyor of crushed substrate is freed from parts of detached fiberglass.

The air sucked by the filtering device ventilator enters the entire device by the filler opening, while the air passing through the crushing space carries out the function of a refrigerant and maintains the temperature of recyclate at an appropriate level. Moreover, the vacuum ventilator maintains a vacuum in the dust retaining device preventing emission of the glass dust into the environment through the filler opening for insertion of products to be processed. In the filtering device the solid glass particles are filtered off, collected in a dust spread preventing container, and the air going out of the filtering device is free of all solid particles.

### BRIEF DESCRIPTION OF THE DRAWINGS

An embodiment of the device according to the invention is schematically shown in the accompanying drawings in which

FIG. 1 is a perspective view of the device.

FIG. 2 is an axial end view of two crush rolls,

FIG. 3 shows the floor projection of a pair of crush rolls and

FIG. 4 is a detail showing a mutual position of the two meshing crush rolls.

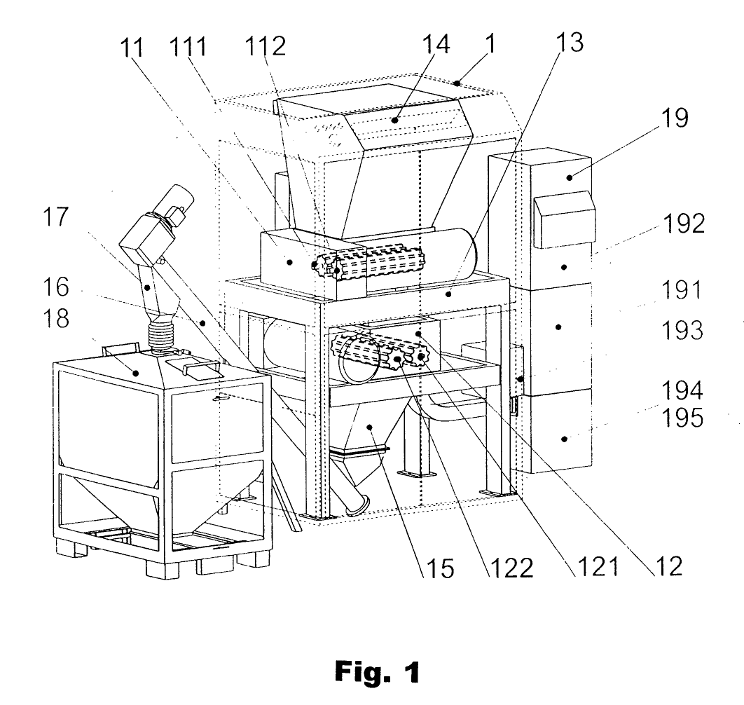

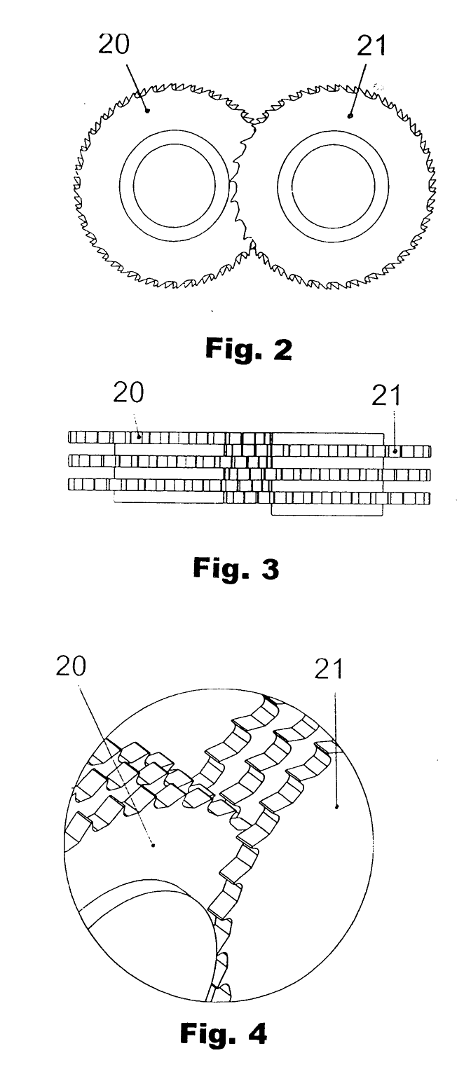

### DESCRIPTION OF A PREFERRED EMBODIMENT

A device for crushing plastic products and/or semi-manufactured products, in particular of plastic material including fiberglass, for example polypropylene, comprises a crushing device 1 which comprises a first crushing section 11 which comprises a pair of parallel crush rolls 111, 112 fitted with segments 20, 21 where their rims are saw-toothed and a second crushing section 12 consisting of a pair of parallel rolls 121 and 122 fitted with similar segments with saw-toothed rims. The first and the second crushing sections are placed in a shared case 13. In the upper part over the first crushing section 11, the case is fitted with a filler opening 14. The pair of parallel crush rolls 111, 112 of the first crushing section 11 are arranged in a horizontal plane and the rolls have axes that are parallel to the longitudinal axis of the filler opening 14.

The pair of parallel crush rolls 121, 122 of the second crushing section 12 is arranged in a horizontal plane while the axes of crush rolls 121, 122 are perpendicular to the axes of crush rolls' 111, 112 axes in a projection of the first crushing section 11.

Under the second crushing section 12 is a feed hopper 15 of the conveyor 16 which is fitted with a conveyor screw coupled with a drive mechanism positioned in the upper part of the conveyor 16. A discharge hopper 17 is connected to the upper part of the conveyor 16. A closed crushed substrate storage bin 18 is positioned under the hopper.

The case 13 is connected with the filtering device 19 which at an air intake comprises a filtering chamber 191 with a ventilator chamber 192 positioned above the chamber 191. The filtering chamber 191 is arranged on a frame for dusting 193 having a lower part on which a discharge hopper 194 is positioned. Under the discharge hopper 194 there is a dust container 195. In view of the dust retaining construction of the entire device, from the filler opening 14 to the crushed substrate storage bin 18 on one side to a ventilator chamber 192 on the other side, air entering the entire device due to suction of the ventilator of the ventilator chamber 192 comes only from the filler opening 14.

Between the first crushing section 11 and the second crushing section 12 there can be inserted an interconnecting component of appropriate shape which orients relatively long parts of material produced by crushing in the first crushing section 11 to a direction approximately perpendicular to the axes of crush rolls 121, 122 of the second crushing section 12.

The crush rolls 111, 112, 121, 122 comprise segments 20, 21 fitted with saw-toothing tilted in the direction contrary to the rotations of crush rolls 111, 112, 121, 122 in both of sections 11 and 12. The segments 20 are on the hub of crush rolls 111, 121 positioned in spacing corresponding to the diameter of segments 21 positioned on the opposite meshing crush roll 112, 122. This causes the segments 20 of one crush roll 111 to fit the holes between segments 21 of the second crush roll 112 of the first crushing section 11. The design is similar in the second crushing section 12. Between the peaks of the saw-toothing and the opposed roll surface there is an indispensable clearance. The width of particular segments 20, 21, the tooth spacing and spin velocity of the crush rolls 111, 112, 121, 122 affect the diameters of crushed parts. The segments 20, 21 of the first and the second crushing section 11, 12 have different toothing diameters where the first crushing section 11 has preferably the segments 20, 21 wider and the toothing spacing larger in comparison to the second crushing section 12. The spin velocity of the crush rolls 121, 122 of the second crushing section 12 is higher than the spin velocity of the crush rolls 111, 112 of the first crushing section 11.

To reduce wear of the segments it is preferred that the crush rolls in one crushing section rotate at different velocities, which prevents meeting of the same parts of the segments 21, 20 of the first and the second crush roll. The crush rolls 111, 112, 121, 122 rotate at a low velocity, ranging from tens to ones revolutions per minute.

Technologically advantageous low spin velocity of crush rolls 111, 112, 121, 122 does not induce turbulence of air, dust and dusting fiberglass and the entire device has a low operating noise level.

The suction power of the filtering device 19 and the dust retaining property of the entire device prevent emission of dust particles heavier than 3 mg. The filtering device 19 itself is in the represented embodiment rated to entrap dust particles heavier than 1 mg.

To prevent unequal congestion or clogging of particular parts of the entire device, the device works in an automatically operated mode so as to indicate undesired conditions. According to the conditions, the device e.g. regulates revolutions of the crush rolls' 111, 112, 121, 122 of the first 11 and the second crushing section 12 (for instance, during congestion of the second crushing section 12, the first crushing section 11 is stopped) and controls the action of filtering device 19 (retarded filtration shut down after crushing sections 11, 12 stopping, dusting-off the filters, level of filter soiling indication) and the conveyor 16.

The dimensions of the crushed parts produced in the first crushing section 11 depend on the width of toothing and the tooth spacing of the segments 20, 21. These toothing parameters are selected so that the length of crushed parts going out of the first crushing section 11 is five times higher than their transverse diameter. As the parts cross the second crushing section 12 where on its crush rolls 121, 122 longitudinal crushed parts come in the direction approximately parallel to the axes of crush rolls 121, 122 particles are produced which are of the same or similar diameters where the diameters are selected according to requirements and are given by the dimension of the crush rolls' 121, 122 of the second section toothing or as the case may be of the both crushing sections.

Typical products being processed are tabular moldings or their parts that are inserted into the filler opening 14 of the crushing device 1 and pass between the crush rolls 111, 112 of the first crushing section 11. The goal at the end of the working process, that is in the storage bin 18, is to have solid particles of a plastic fiberglass-armored corresponding to the requirements for their recycling and which are possible to add in a particular ratio to a mixture for a new production. Tests confirm that by adding the recyclate of an appropriate particle size (for example chips of a surface area 12×12 mm or smaller) to a mixture for armored plastic production lowers the scrap of semi-manufactured products produced by up to 30% in comparison to a production without use of such recyclate.

The device according to the invention can also be used for crushing non-armored plastics, e.g. PET bottles, to not only simplify next ecological disposal but also to simplify recycling. According to the size and the shape of crushed products, the crushing device would be fitted at the front end with an additional inserting feed hopper of appropriate size and another pair of rolls for perforating the processed products, e.g. closed plastic bottles and for compressing them to a tabular shape appropriate for feeding to the first crushing section 11. This described complementary device is not shown.

The present arrangements expand the practical use of the invention. Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A device for crushing products of a plastic material, the device comprising
a first crushing section comprised a pair of parallel first crush rolls each fitted with first teeth;
a second crushing section comprised a pair of second parallel crush rolls each fitted with second teeth;
a shared space in which both crushing sections are positioned, the space being fitted with a filler opening on one side and with a crushed substrate storage bin on another side, the second crushing section is positioned below the first crushing section;
axes of the second crush rolls of the second crushing section are in a floor projection positioned approximately perpendicularly to axes of the first crush rolls of the first crushing section.

2. The device of claim 1, wherein the shared space is interconnected by a feed hopper with a conveyor and is connected through a filtering device with a vacuum source.

3. The device of claim 1, wherein each of the crush rolls is in separated segments, the segments being spaced along the axis of each roll, and each segment having teeth around it, each segment of one roller of each pair of crush rolls having its toothing extend to a non-toothed portion of the other roll of the pair of rolls and extending between toothed segments of the other roll.

4. Device as claimed in claim 3, wherein the first crush rolls of the first crushing section having at least one of larger toothing and larger toothing spacing of the segments than the toothing and tooth spacing of the second crush rolls of the second crushing section.

5. Device as claimed in claim 4, including devices operable so that the spin velocity of the first crush rolls of the first crushing section is lower than the spin velocity of the second crush rolls of the second crushing section.

6. Device as claimed in claim 1, including devices operable so that the spin velocity of the first crush rolls of the first crushing section is lower than the spin velocity of the second crush rolls of the second crushing section.

7. Device as claimed in claim 1, further comprising a crushed substrate conveyor attached to a closed crushed substrate storage bin positioned at a discharge end of the device.

8. Device as claimed in claim 7, wherein the crushed substrate conveyor comprises a screw conveyor.

9. Device as claimed in claim 1, further comprising a filler opening into the device; an attached filtering device having an output; a vacuum ventilator in the output for vacuum formation in the shared dustproof space of the crush rolls, for suction of air through the filler opening and for separation of small plastic particles and from recyclate detached fiberglass of desired grain size.
